(19) United States
(12) Patent Application Publication
(10) Pub. No.: US 2022/0110825 A1
(43) Pub. Date: Apr. 14, 2022

(54) STEPLESSLY ADJDUSTED FASCIA GUN

(71) Applicant: Guangdong Yongsheng Technology Development Co., Ltd, Guangzhou (CN)

(72) Inventors: Andi Hong, Guangzhou (CN); Lihua Du, Fengcheng (CN)

(21) Appl. No.: 17/645,966

(22) Filed: Dec. 24, 2021

(51) Int. Cl. A61H 23/02

(52) U.S. Cl. CPC A61H 23/02; A61H 2201/5043; A61H 2201/1207

(57) ABSTRACT

The present invention discloses a steplessly adjusted fascia gun. The steplessly adjusted fascia gun comprises a fascia gun main body and a display cover body. An inner cavity of the fascia gun main body is provided with a control panel, the control panel is provided with a hollow shaftless encoder, a rotating position of the hollow shaftless encoder, located at one end of the fascia gun main body, is coaxially provided with a rear cover of a hollow structure, the display cover body penetrates through an inner ring of the rear cover and an inner ring of the hollow shaftless encoder in sequence and is fixed to the control panel, the control panel is provided with a display apparatus on an inner side of the display cover body, and the control panel is provided with a button.

### BACKGROUND OF THE INVENTION

### 1. Technical Field

The present invention relates to the technical field of fascia guns, in particular to a steplessly adjusted fascia gun.

### 2. Description of Related Art

As everyone knows, a fascia gun, also known as a deep muscular fasciae impacting instrument, is a soft tissue rehabilitation tool. A specially made high speed motor in the fascia gun drives a “gun head” to generate high frequency vibration acted to deep muscles, thereby playing roles of alleviating local tissue tension, relieving pain, promoting blood circulation and the like.

For an existing fascia gun, the massage frequency is often adjusted by using plus and minus buttons. Both hands are needed and the buttons are pressed vigorously to operate, the adjusting vigor may not be adjusted at will and may only be adjusted according to a certain gear stage, so that the user experience is poor. There are still some fascia guns in the market, the massage frequencies of which are steplessly adjusted via rotary knobs. However, the rotary knob is connected with a rotary shaft and an encoder in sequence to adjust the massage frequency, and as the encoder is built-in, the built-in encoder will occupied an inner space of the body. If a display apparatus is mounted in a narrow body, the rotary knob is mounted at the display apparatus, so that the rotary knob and the display apparatus rotate together, thereby, it is inconvenient for the user to observe the display apparatus. Furthermore, it is quite inconvenient for the user to operate.

### BRIEF SUMMARY OF THE INVENTION

In order to overcome deficiencies in the prior art, the objective of the present invention is to provide a steplessly adjusted fascia gun.

In order to achieve the purpose, the present invention adopts a technical scheme as follows:

A steplessly adjusted fascia gun, including a fascia gun main body and a display cover body, wherein an inner cavity of the fascia gun main body is provided with a control panel, the control panel is provided with a hollow shaftless encoder, a rotating position of the hollow shaftless encoder, located at one end of the fascia gun main body, is coaxially provided with a rear cover of a hollow structure, the display cover body penetrates through an inner ring of the rear cover and an inner ring of the hollow shaftless encoder in sequence and is fixed to the control panel, the control panel is provided with a display apparatus on an inner side of the display cover body, and the control panel is provided with a button exposed out of the display cover.

Preferably, an outer surface of the rear cover is provided with an annular groove, and the display cover body is provided with a limiting portion sleeved in the annular groove.

Preferably, the display apparatus is a nixie tube or a display screen or an LED lamp.

Preferably, the outer surface of the rear cover is provided with an anti-skid portion.

Preferably, the display cover body is transparent or semi-transparent.

Preferably, the display cover body is fastened to the control panel via a screw.

By adopting the technical scheme, the control panel of the inner cavity of the fascia gun main body is provided with the hollow shaftless encoder, the rotating position of the hollow shaftless encoder, located at one end of the fascia gun main body, is coaxially provided with the rear cover of the hollow structure, and the display cover body penetrates through the inner ring of the rear cover and the inner ring of the hollow shaftless encoder in sequence and is fixed to the control panel. Therefore, the display cover body, the display apparatus and the button are all mounted at the inner rings of the rear cover and the hollow shaftless encoder via the control panel. Thus, when the rear cover is rotated to adjust a massage frequency, the display apparatus and the button are fixed relative to the fascia gun main body, thereby, it is convenient for a user to observe the display apparatus. When the fascia gun main body is held, the rear cover may be rotated with a single handle finger as well, so that it may be operated with a single hand, and therefore, the convenience of user operation is enhanced effectively. The massage frequency may further be steplessly adjusted, so that it is relatively humanized to operate, and therefore, the using experience of the user is improved greatly. The finger of the user rotates the rear cover directly to directly rotate the hollow shaftless encoder to adjust the massage frequency steplessly. The fascia gun is fewer in part integrally, simple in structure, quick in operation response and easy and comfortable to adjust. The massage frequency may be adjusted steplessly by rotating the rear cover left and right by the user, so that it is quite convenient to operate and is of very high practicality.

### BRIEF DESCRIPTION OF THE SEVERAL VIEWS OF THE DRAWINGS

FIG. 1 is an isometric diagram of an embodiment of the present invention.

FIG. 2 is a section view of an embodiment of the present invention.

FIG. 3 is an exploded view of an embodiment of the present invention.

In the drawings:

1, fascia gun main body; 2, display cover body; 3, control panel; 4, encoder; 5, rotating position; 6, rear cover; 7, display apparatus; 8, button; 9, annular groove; 10, limiting portion; 11, anti-skid portion; 12, screw.

### DETAILED DESCRIPTION OF THE INVENTION

Detailed description is made on the embodiments of the present invention below in combination with drawings. However, the present invention may be implemented by various different modes defined and covered by Claims.

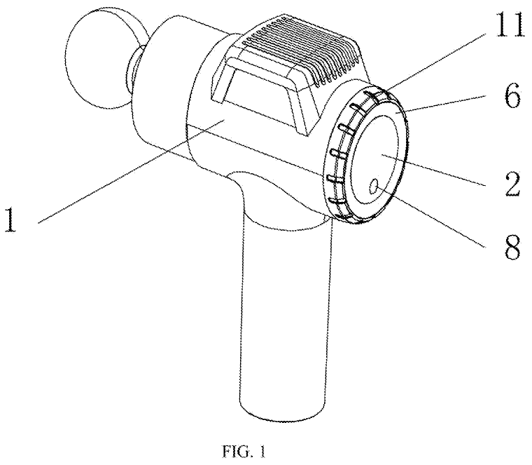

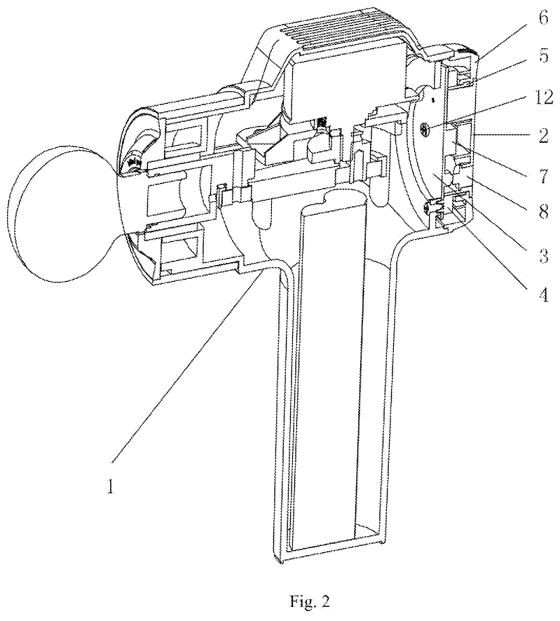

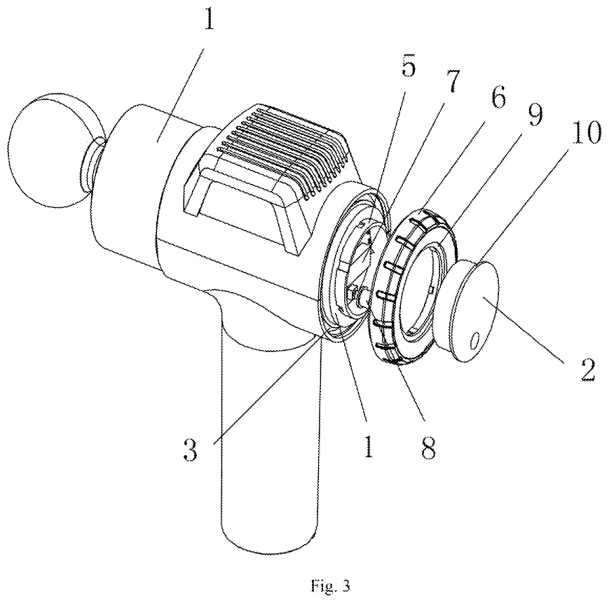

As shown in FIG. 1 to FIG. 3, a steplessly adjusted fascia gun provided by the embodiment includes a fascia gun main body 1 and a display cover body 2, wherein an inner cavity of the fascia gun main body 1 is provided with a control panel 3, the control panel 3 is provided with a hollow shaftless encoder 4, a rotating position 5 of the hollow shaftless encoder 4, located at one end of the fascia gun main body 1, is coaxially provided with a rear cover 6 of a hollow structure, the display cover body 2 penetrates through an inner ring of the rear cover 6 and an inner ring of the hollow shaftless encoder 4 in sequence and is fixed to the control panel 3, the control panel 3 is provided with a display apparatus 7 on an inner side of the display cover body 2, and the control panel 3 is provided with a button 8 exposed out of the display cover 2.

Further, an outer surface of the rear cover 6 of the embodiment is provided with an annular groove 9, and the display cover body 2 is provided with a limiting portion 10 sleeved in the annular groove 9. Therefore, when the display cover body 2 is fixed to the control panel 3, the limiting portion 10 may limit the rear cover 6 between the fascia gun main body 1 and the display cover body 2, so that it is unnecessary to limit the rear cover 6 by means of the screw 12. The structure is skillful in design and convenient to mount, the production cost is lowered effectively, the whole fascia gun is in smooth transition in outer surface, so that the aesthetic degree of the outer surface of the whole fascia gun is increased.

Further, the display apparatus 7 in the embodiment is a nixie tube or a display screen or an LED lamp. The embodiment does not define the type of the specific display apparatus 7 specifically here.

Further, an outer surface of the rear cover 6 in the embodiment is provided with an anti-skid portion 11. By arranging the anti-skid portion 11, a friction force may be provided, thereby, enhancing the rotating stability of the rear cover 6 during operation effectively.

Further, the display cover body 2 in the embodiment is transparent or semi-transparent.

Further, the display cover body 2 in the embodiment is fastened to the control panel 3 via a screw 12.

When the embodiment works actually, the control panel 3 of the inner cavity of the fascia gun main body is provided with the hollow shaftless encoder 4, the rotating position 5 of the hollow shaftless encoder 4 is coaxially provided with the rear cover 6 of the hollow structure, and the display cover body 2 penetrates through the inner ring of the rear cover 6 and the inner ring of the hollow shaftless encoder 4 in sequence and is fixed to the control panel 3. Therefore, the display cover body 2, the display apparatus 7 and the button 8 are all mounted at the inner rings of the rear cover 6 and the hollow shaftless encoder 4 via the control panel 3. Thus, when the rear cover 6 is rotated to adjust a massage frequency, the display apparatus 7 and the button 8 are fixed relative to the fascia gun main body 1, thereby, it is convenient for a user to observe the display apparatus 7. When the fascia gun main body 1 is held, the rear cover 6 may be rotated with a single handle finger as well, so that it may be operated with a single hand, and therefore, the convenience of user operation is enhanced effectively. The massage frequency may further be steplessly adjusted, so that it is relatively humanized to operate, and therefore, the using experience of the user is improved greatly. The finger of the user rotates the rear cover 6 directly to directly rotate the hollow shaftless encoder 4 to adjust the massage frequency steplessly. The fascia gun is fewer in part integrally, simple in structure, quick in operation response and easy and comfortable to adjust. The massage frequency may be adjusted steplessly by rotating the rear cover 6 left and right by the user, so that it is quite convenient to operate and is of very high practicality.

The above is merely preferred embodiments of the application and does not hence limit the patent range of the application. Equivalent structure or equivalent flow conversion made by means of the contents of the description and drawings of the application are applied to other related technical fields directly or indirectly, which is, in a similar way, comprised in the protection scope of the patent of the application.

What is claimed is:

1. A steplessly adjusted fascia gun, characterized by comprising a fascia gun main body and a display cover body, wherein an inner cavity of the fascia gun main body is provided with a control panel, the control panel is provided with a hollow shaftless encoder, a rotating position of the hollow shaftless encoder, located at one end of the fascia gun main body, is coaxially provided with a rear cover of a hollow structure, the display cover body penetrates through an inner ring of the rear cover and an inner ring of the hollow shaftless encoder in sequence and is fixed to the control panel, the control panel is provided with a display apparatus on an inner side of the display cover body, and the control panel is provided with a button exposed out of the display cover.

2. The steplessly adjusted fascia gun as claimed in claim 1, characterized in that an outer surface of the rear cover is provided with an annular groove, and the display cover body is provided with a limiting portion sleeved in the annular groove.

3. The steplessly adjusted fascia gun as claimed in claim 1, characterized in that the display apparatus is a nixie tube or a display screen or an LED lamp.

4. The steplessly adjusted fascia gun as claimed in claim 1, characterized in that the outer surface of the rear cover is provided with an anti-skid portion.

5. The steplessly adjusted fascia gun as claimed in claim 1, characterized in that the display cover body is transparent or semi-transparent.

6. The steplessly adjusted fascia gun as claimed in claim 2, characterized in that the display cover body is fastened to the control panel via a screw.
